(19) United States
(12) Patent Application Publication
(10) Pub. No.: US 2023/0100951 A1
(43) Pub. Date: Mar. 30, 2023

(54) PLATFORM FOR PACKET CAPTURE EXCHANGE AND ANALYSIS

(71) Applicants: Oleg A Sinitsin, Peachtree Corners, GA (US); Adam W. Pumphrey, Davidsonville, MD (US); Farel Jamin Becker, Morganton, NC (US)

(72) Inventors: Oleg A Sinitsin, Peachtree Corners, GA (US); Adam W. Pumphrey, Davidsonville, MD (US); Farel Jamin Becker, Morganton, NC (US)

(21) Appl. No.: 17/934,530

(22) Filed: Sep. 22, 2022

Related U.S. Application Data
(60) Provisional application No. 63/248,776, filed on Sep. 27, 2021.

(51) Int. Cl. H04L 9/40; H04L 43/062

(52) U.S. Cl. CPC H04L 63/1433; H04L 63/1425; H04L 43/062

(57) ABSTRACT

A system or platform for network packet capture exchange and analysis may include a means for receiving, processing, analyzing, displaying, and retrieving packet capture data to a user(s) or third-party system(s). Packet capture data may be analyzed via machine-processing, data enrichments, visualizations, and the like, including network traffic analysis and malware analysis.

### CROSS-REFERENCE TO RELATED APPLICATIONS

This application claims the benefit of U.S. Provisional Application No. 63/248,776 filed Sep. 27, 2021.

### TECHNICAL FIELD

The embodiments generally relate to the field of packet capture (PCAP) and analysis.

### BACKGROUND

PCAP files, including a variety of technical formats, such as pcap, pcapng, libpcap, winpcap, npcap, and the like, contain a complete copy of live computer network traffic, and are essential for cyber threat detection, network behavior analysis, network performance measurement, and the like. Methods of PCAP file analysis may include a software application installed on a personal computer that may open and dissect individual PCAP files. Alternatively, methods of PCAP file analysis may include an online platform that may receive and analyze individual PCAP file(s) via manual user uploads. PCAP data may be parsed, categorized, filtered, and displayed to a user.

Existing platforms lack effective systems for programmatic identification and upload of PCAP files of interest, dynamic scaling of processing relating to ingestion and analysis of PCAP files, analytical reporting, analytic code development and deployment, repeatable machine-enabled analysis of PCAP files, or PCAP analysis from malware detonation.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

A system or platform for PCAP exchange and analysis may include a means for receiving PCAP data, parsing and enriching PCAP data, filtering and searching PCAP data, performing machine analytics and cyber threat detection within PCAP data and datasets, and displaying analytic PCAP information to a user(s) via an integrated graphical user interface (GUI).

In one aspect, the system may include drag-and-drop functionality configured to allow users to upload single PCAP files. In one aspect, the system may be configured to receive a plurality of PCAP files from a user in a multi-file upload function or automatically via an application programming interface (API).

In one aspect, the system may allow a user to manage files and access controls within a private, controlled environment for PCAP analysis.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and features thereof will be more readily understood by reference to the following detailed description when considered in conjunction with the accompanying drawings, wherein:

FIG. 1 illustrates a simplified system diagram of one variation of a platform for PCAP exchange and analysis according to some embodiments described herein;

FIG. 2 illustrates a simplified system diagram of a portion of one variation of a platform for PCAP exchange and analysis according to some embodiments described herein;

FIG. 3 illustrates a simplified system diagram of a portion of one variation of a platform for PCAP exchange and analysis according to some embodiments described herein;

FIG. 4 illustrates a simplified system diagram of a portion of one variation of a platform for PCAP exchange and analysis according to some embodiments described herein;

FIG. 5 illustrates a simplified system diagram of a portion of one variation of a platform for PCAP exchange and analysis according to some embodiments described herein;

FIG. 6 illustrates a simplified system diagram of a portion of one variation of a platform for PCAP exchange and analysis according to some embodiments described herein;

FIG. 7 illustrates one variation of a graphical user interface for a platform for PCAP exchange and analysis according to some embodiments described herein;

FIG. 8 illustrates one variation of a graphical user interface for a platform for PCAP exchange and analysis according to some embodiments described herein; and

FIG. 9 illustrates one variation of a graphical user interface for a platform for PCAP exchange and analysis according to some embodiments described herein.

The drawings are not necessarily to scale, and certain features and certain views of the drawings may be shown exaggerated in scale or in schematic in the interest of clarity and conciseness and should not be considered limiting.

### DETAILED DESCRIPTION

The specific details of the single embodiment or variety of embodiments described herein are to the described system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, apparatus, or computer program product at any possible technical detail level of integration. A computer application or mobile application product can include, among other things, a computer-readable storage medium having computer-readable program instructions thereon for causing a processor to carry out aspects of the present disclosure.

Generally, a “computing device” as referenced herein will include or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

As used herein, the term “user” may relate to any person interacting with the various features of the system provided herein as well as users who administer the system.

As used herein, “GUI” may refer to any graphical user interface that includes at least one interactive component between a user and the application. A GUI may include a plurality of fillable fields, clickable buttons, database displays, and the like. A GUI may be adaptable for use on several devices such as computers, phones, smart devices, tablets, laptops, televisions, and the like.

In general, the embodiments described herein relate to an online platform or system for analytic research and exchange of network datasets, stored in the format of PCAP files. The system may include a GUI configured to allow a user of the system to ingest, manage, analyze, and perform various other functions with respect to PCAP files and data. Any of the described modules may be implemented on a computer device in operable communication with a network or on a plurality of computer devices in operable communication with one another, over a network, or both. Any number of users may interact with the system via an internet browser on various computer devices either via public or private web pages requiring access permissions. Any number of external third-party systems may interact with the system programmatically via an API requiring access permissions.

The system may include a PCAP Data Ingestion module configured to allow for manual or API based data ingestion and multi file upload from a user or other system. In a Simple-Ingest mode, the PCAP Data Ingestion module may allow users to upload individual or multiple PCAP files via an online GUI or file transfer software, such as a web page, secure FTP client, and the like. In a API-Ingest mode, the PCAP Data Ingestion module may provide an API endpoint to programmatically upload PCAP files to the system. In a Smart-Ingest mode, the PCAP Data Ingestion module may be integrated with an external data source, such as the cloud or on-premise storage, and the like, to programmatically identify and upload PCAP files of interest, such as via the PCAP Network Analyzer module described subsequently. As a non-limiting example, the Smart-Ingest mode may programmatically crawl, such as explore a file management system, an object storage system, or a data lake, and the like, the external data source and identify PCAP files with network traffic content matching certain criteria and then upload the identified PCAP files automatically via API-Ingest or with manual intervention via Simple-Ingest. The Smart-Ingest mode may provide for the assembly of multiple PCAP files into a single analytic dataset, such as a new PCAP file combining individual PCAP files, or a group of individual PCAP files marked as members of a dataset.

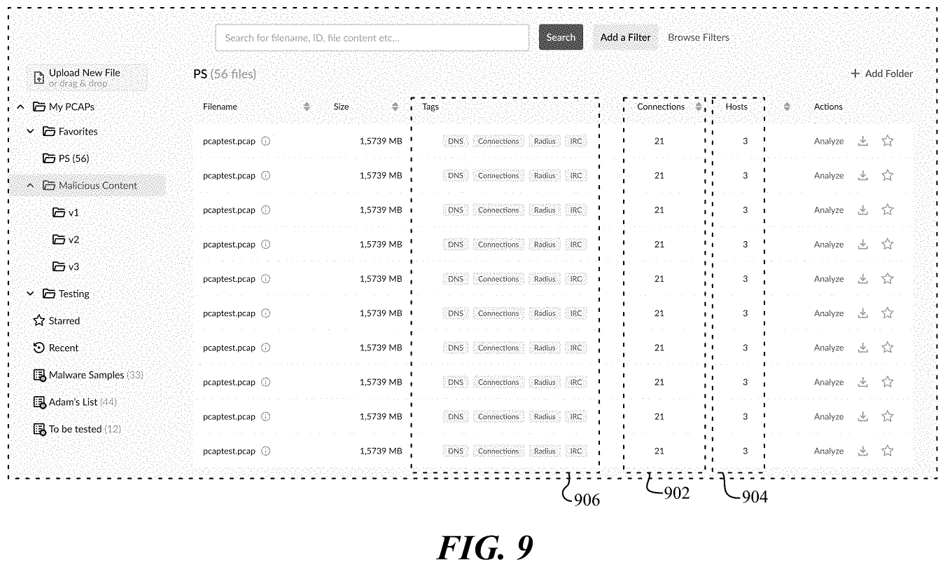

The system may include a PCAP Network Analyzer module providing a mechanism to deploy and run the purpose-built software for programmatically analyzing network traffic contained in PCAP files stored on the platform, or PCAP files stored on external data source, and the like for the purposes of cyber threat detection, network performance measurement, and the like. The type of PCAP network analyzer software may include custom or off-the-shelf software, such as Deep Packet Inspection (DPI), Network Intrusion Detection System (NIDS), Network Security Monitor (NSM), network sensor, packet dissector, data science program, and any other software suitable for analyzing or manipulating the contents of PCAP files. The PCAP Network Analyzer module may consist of analyzer worker nodes. The analyzer worker nodes may be used to dynamically scale processing loads of ingested PCAP files. Each analyzer worker node represents a run-time software instance, such as a software container, a virtual machine, and the like, that runs PCAP Network Analyzer software. The system may be started with a certain number of pre-configured analyzer worker nodes. When the system detects the need to increase PCAP processing capacity, the system may instantiate new analyzer worker nodes to accommodate the increased PCAP load for scalable, high-volume analysis of the ingested PCAP data. The PCAP Network Analyzer module may be used to receive ingested PCAP files from the PCAP Data Ingestion module. Additionally, the PCAP Network Analyzer module may be embedded into the PCAP Data Ingestion module for data ingest pre-processing and identifying PCAP files of interest during Smart-Ingest or may be employed via Smart-Ingest to generate a preview of relevant PCAP files of interest. As a non-limiting example, the Smart-Ingest process may run a network analyzer instance to determine PCAP files with certain types of network traffic content, such as network traffic behavior or PCAP file properties, marking them for automated ingestion into the system. Network traffic behavior may include network flows and telemetry properties, including IP addresses, protocols, ports, timestamps, and the like; network protocol transcripts, including protocol-specific fields, attributes, payloads, and the like; alerts of suspicious or anomalous activity; network host categorization, network metadata, and the like. PCAP file properties may include a number of network connections or network hosts contained therein, network analytic tags, network connection durations, timestamps of first and last packet, embedded artifacts, such as files, encryption certificates, and the like as further described in FIG. 9.

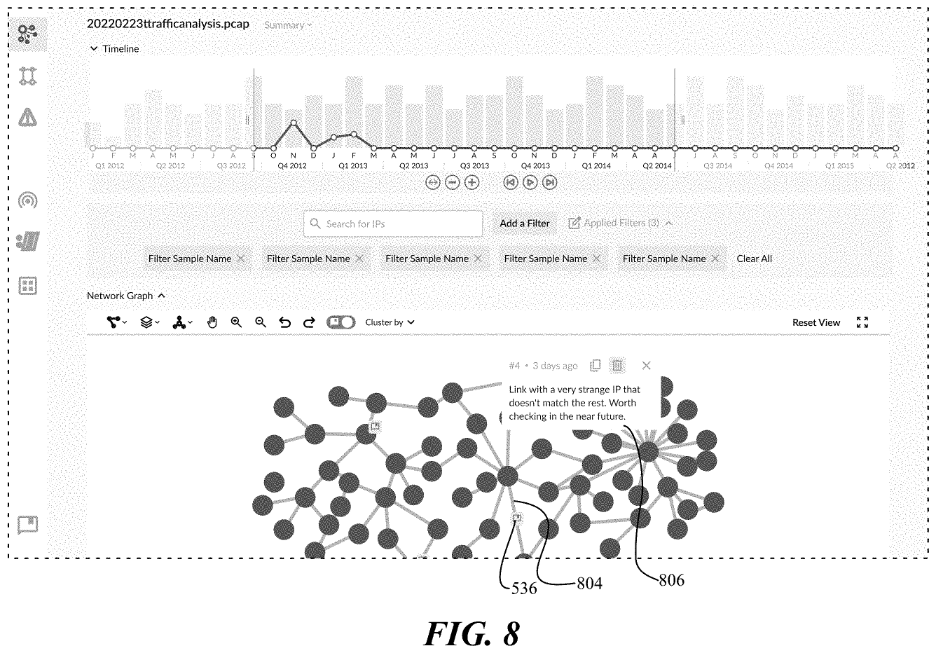

The system may include a Private PCAP Space accessible to select users. The Private PCAP Space may be configured to allow users to privately manage their files, access controls, and group projects, such as file sharing and analytic collaboration among authorized users of the system. The system may be also configured for public analysis and display of PCAP file data as received from a user or multiple users in a public PCAP space, such as a generally accessible public dashboards integrated with the GUI. The Private PCAP Space may include a Data Operations component for storing, indexing, searching, retrieval, deletion, and the like of PCAP files as well as the analytic data extracted from the PCAP files, such as network metadata, artifacts, connection logs, network protocol transcripts, packet-level data, and the like. The Private PCAP Space may include an Identity and Access Management (IAM) component for managing user lifecycle and access permissions. The Private PCAP Space may include the Evidence Collection and Collaboration component, providing functionality for documenting investigations of network behavior and exchanging such investigation information among users. The Evidence Collection and Collaboration component may provide a mechanism for gathering and exchanging network traffic artifacts, creation of analytic reports, inserting and sharing contextual deep links inside PCAP analytic views, organizing evidence in the storyboard format, and the like. The network traffic artifacts may include files embedded inside PCAP files, such as malware, encryption certificates, transmitted files, and the like. As a non-limiting example, analytic reports may include data such as, but not limited to, user notes, user or system generated screenshots, system-generated analytic data, and the like. The contextual deep links enable URL bookmarking of the PCAP data elements in analytic PCAP data views for referencing a specific PCAP data element. A contextual deep link may contain a URL field, a description field, associated keywords, cross-references to related PCAP data elements, and the like, as illustrated in FIG. 8. As a non-limiting example, a contextual deep link may be associated with an IP host, communications link, network artifact, and the like, providing a quick way of accessing such a PCAP data element in a PCAP analytic view via a URL link for the purposes of documentation, commenting, reporting, sharing with other users, and the like. The Evidence Collection and Collaboration component may further include integrations with third-party messaging, ticketing, workflow systems, and the like to enable collaboration, transmission of evidence, and deep linking to PCAP analytic views.

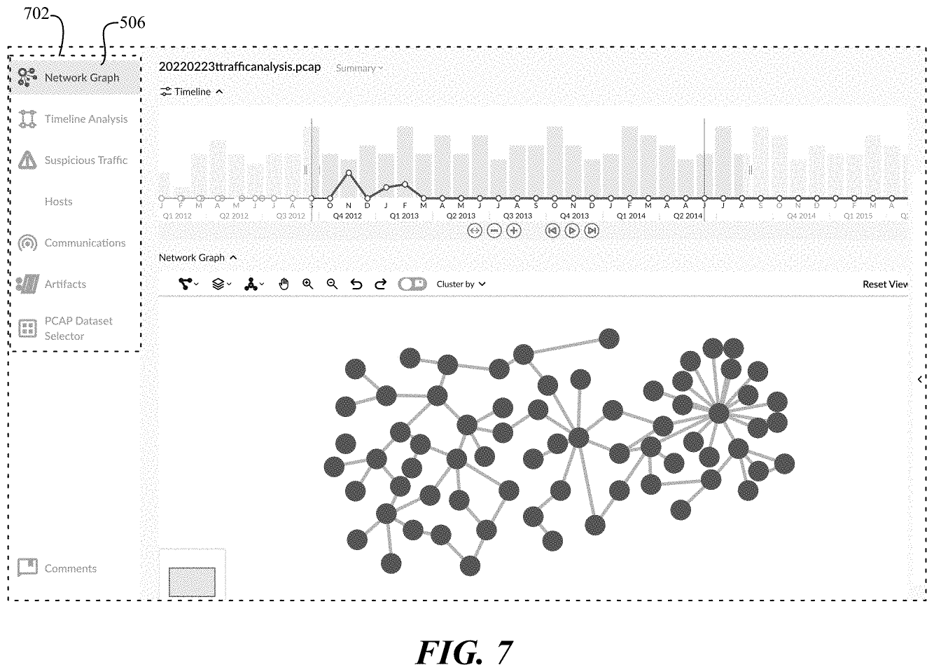

The system may include a PCAP Analytic Environment configured for PCAP analysis. The PCAP Analytic Environment may include a network graph or a network map visual component, as depicted in FIG. 7, that displays network traffic in the form of interconnected network hosts, enriched with additional information, such as host and connection details, security alerts, file transfers, network performance indicators, and the like. The PCAP Analytic Environment may include a timeline analysis component that displays network traffic in the form of communication events between network hosts, overlayed on top of an interactive timeline visualization and enriched with additional communication details. The PCAP Analytic Environment may include a packet-level analysis component that displays network packet exchange between hosts, overlayed on top of an interactive timeline visualization and enriched with additional packet-level details. The PCAP Analytic Environment may include a suspicious traffic component that displays views of suspicious cybersecurity activities, risk categories, enrichment information, and the like. The PCAP Analytic Environment may include a hosts component that displays views of network hosts, including communication details, network asset profiles, enrichment information, and the like. The PCAP Analytic Environment may include a communications component that displays views of network communications, such as network flows, network protocol communications, and the like, including connection details, enrichment information, and the like. The PCAP Analytic Environment may include an artifacts component that displays views of network artifacts, such as extracted files, encryption certificates, and the like. The PCAP Analytic Environment may include a data trends component that displays a variety of analytic visualizations, such as charts, graphs, tables, lists and the like, with statistical or machine-learning analysis of network traffic. The PCAP Analytic Environment may include a data science software development kit (SDK) component, in a form of a purpose-built software library, to facilitate programmatic data query, search, transformation into data frames, analytic functions, and the like. The PCAP Analytic Environment may include a data science GUI component that provides an embedded programming environment, such as interactive notebooks and the like, for writing and executing computer software code to analyze network traffic data. The PCAP Analytic Environment may include a code deployment and run-time component that provides an automated process to package the analytic code and deploy the analytic code in a run-time environment, such as a network analyzer and the like, for the purposes of repeatable machine-enabled analysis of PCAP files and processed network traffic data stored in the system.

The system may include a PCAP Malware Analyzer configured for the analysis of malicious files that may be embedded in PCAP data ingested by the system, such as, but not limited to, antivirus checks and malware scan engines, malware classification via YARA rules or similar methods, or malware detonation analysis in a sandbox environment. The PCAP Malware Analyzer may provide a mechanism to extract malware of interest from PCAP files. The PCAP Malware Analyzer may classify malware samples extracted by the system from PCAP files and present the malware classification for users to explore, download, and detonate in a sandbox or virtual environment for further analysis. The PCAP Malware Analyzer may perform malware validation to determine if it is suitable for detonation. The PCAP Malware Analyzer may programmatically launch a sandbox instance and detonate the malware sample. The PCAP Malware Analyzer may capture network traffic from malware detonation within a sandbox environment into a PCAP file and programmatically ingest the resulting sandbox PCAP file to the system for network traffic analysis.

The following description of figures is for illustrative purposes only and should not be considered preferred embodiment(s) or implementations of the disclosed system and, therefore, should not be considered limiting.

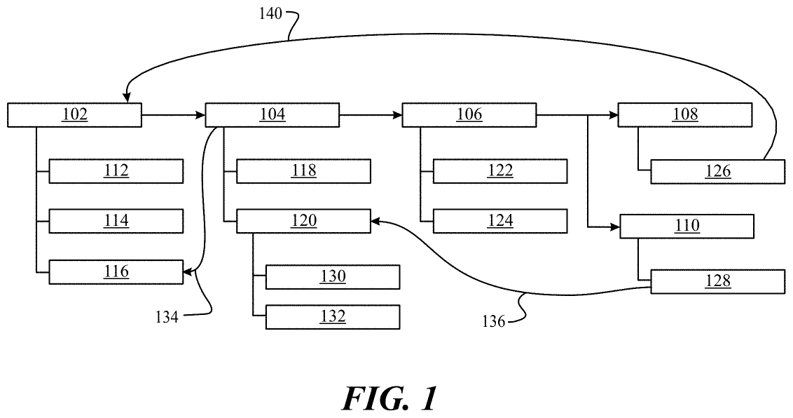

Referring to FIG. 1, a platform for packet capture exchange and analysis may include a PCAP data ingestions module 102, a network analyzer module 104, a private PCAP space 106, a malware analyzer 108, and a PCAP analytic environment 110.

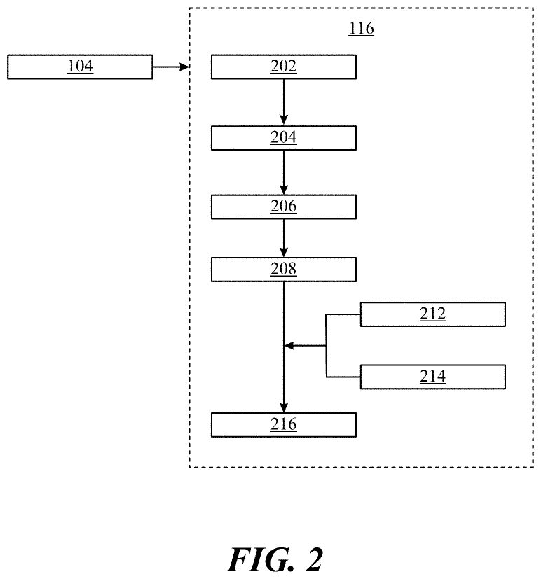

The PCAP data ingestion module 102 may be configured for simple ingest 112 of PCAP files, API-ingest 114, or Smart-ingest 116. Smart-ingest 116, which is further described in the description of FIG. 2, may programmatically identify and upload PCAP files of interest within an external data source. Smart-Ingest 116 may programmatically crawl the external data source and identify PCAP files with network traffic content matching certain criteria and then upload the identified PCAP files via API-Ingest or Simple-Ingest. Smart-ingest 116 may provide the assembly of multiple PCAP files into a single analytic dataset, such as a new PCAP file combining individual PCAP files or as a group of individual PCAP files marked as members of a dataset.

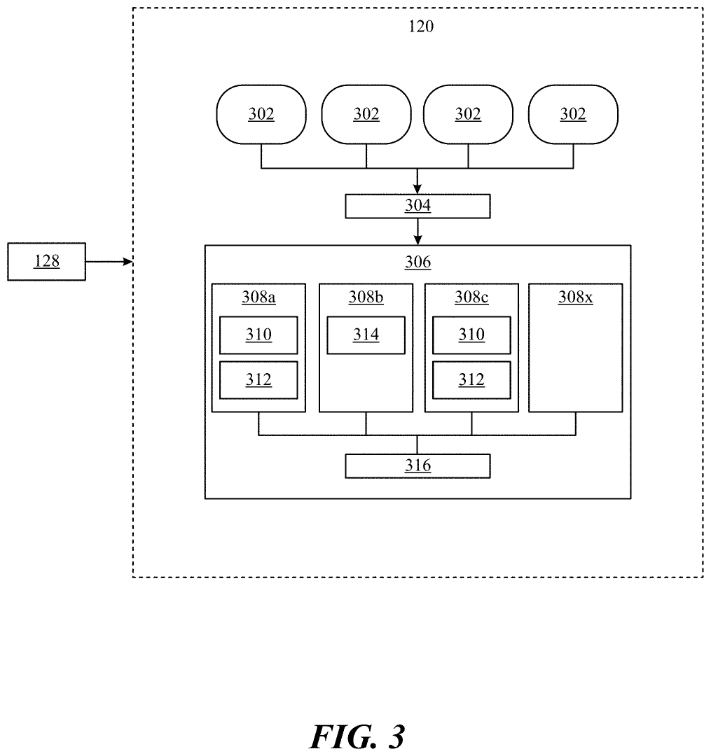

The network analyzer module 104 may be used to receive ingested PCAP files from the PCAP data ingestion module 102 and may programmatically analyze network traffic contained in PCAP files stored on the platform, or PCAP files stored on external data source, and the like, for the purposes of cyber threat detection, network performance measurement, and the like. Network analyzer module 104, which is further described in the description of FIG. 3, may include a pool of analyzer worker nodes onto which a variety of network analyzer types 118 may be deployed, such as, but not limited to, DPI, NIDS, NSM, network sensor, packet dissector, data science program, or any other software suitable for analyzing or manipulating the contents of PCAP files.

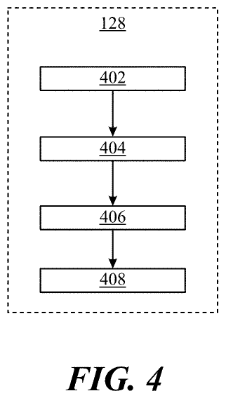

Network analyzer module 104 may consist of various deployed network analyzers 120 on analyzer worker nodes 130 used to dynamically scale processing loads 132 of ingested PCAP files. Deployed network analyzers 120 may include custom developed analytic code 136 from the PCAP analytic environment 110 and code deployment and run-time component 128, which is further described in the description of FIG. 4.

Network analyzer module 104 may be embedded 134 into the PCAP data ingestion module 102 for data ingest pre-processing and identifying PCAP files of interest during Smart-ingest 116. As a non-limiting example, the Smart-Ingest process may run a network analyzer instance to determine PCAP files with certain types of network traffic behavior or file properties, marking them for automated ingestion into the system.

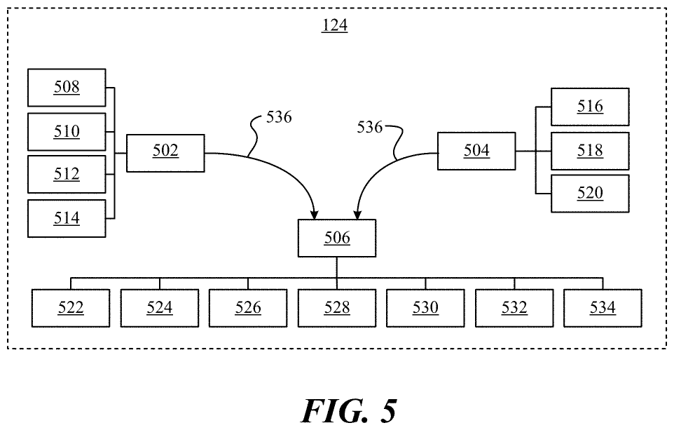

The Private PCAP Space 106 may include management features 122 such as a data operations and an IAM component for managing user lifecycle and access permissions. The Private PCAP Space 106 may include the Evidence Collection and Collaboration component 124, providing for documenting investigations of network behavior and exchanging such investigation information among users, which is further described in the description of FIG. 5. Private PCAP space 106 may further allow for public analysis and display of PCAP file data as received from a user or multiple users in a public PCAP space.

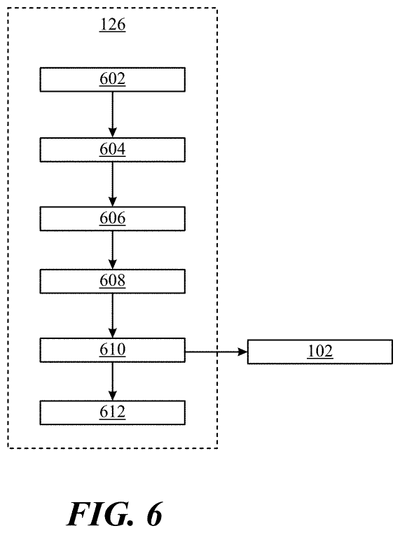

Malware analyzer 108 may be configured for the analysis of malicious files that may be embedded in PCAP data ingested by the system and may provide a mechanism to extract malware of interest from PCAP files. The malware analyzer 108 may classify malware samples extracted by the system from PCAP files and present the malware classification for users to explore, download, or detonate in a sandbox or virtual environment, capture the sandbox traffic to a PCAP file 126 and ingest the PCAP file 126 to the system via the PCAP Data Ingestion module for further analysis 140, discussed further in the description of FIG. 6.

PCAP analytic environment 110 may include an embedded data science development environment for developing and testing software programs purpose-built for analyzing network traffic, including the interactive notebook documents with data science code such as statistical computations, data manipulations, machine-learning techniques, data visualizations, data enrichments and the like. The PCAP analytic environment 110 may include a code deployment and run-time component 128 that provides an automated process to package the analytic code and deploy analytic code 136 in a run-time environment, such as a network analyzer and the like, for the purposes of repeatable machine-enabled analysis of PCAP files and processed network traffic data stored in the system, which is discussed further in the description of FIG. 4.

Referring to FIG. 2, smart-ingest 116 may programmatically identify and upload PCAP files of interest within an external data source 202. A network analyzer module 104 may be embedded 134 into the PCAP data ingestion module for data ingest pre-processing and identifying PCAP files of interest, via customizable criteria 204, during Smart-ingest 116. Smart-Ingest 116 may programmatically crawl 206, such as via the network analyzer module 104, the external data source and identify PCAP files with network traffic content matching certain criteria 204 and then upload 216 the identified PCAP files via API-Ingest or Simple-Ingest. Optionally, Smart-ingest 116 may provide the assembly of multiple PCAP files into a single analytic dataset, such as a new PCAP file combining individual PCAP files 214 or as a group of individual PCAP files marked as members of a dataset 212.

Referring to FIG. 3, the system may perform ingestion 304 of PCAP files 302 and dynamically scale processing loads 306 via various deployed network analyzers 120 utilizing a scalable plurality of analyzer worker nodes 308a, 308b, 308c, and 308x in an analyzer worker node pool 316. Deployed network analyzers 120 may utilize analytic code from the PCAP analytic environment and code deployment and run-time component 128, depicted in FIG. 4. Each analyzer worker node 308a, 308b, 308c, and 308x represents a run-time software instance that runs PCAP Network Analyzer software, such as 310, 312, or 314, and the like. The system may be started with a predetermined number of pre-configured analyzer worker nodes, such as, but not limited to, 308a, 308b, and 308c. The system may be configured to increase or decrease its PCAP ingestion 304 processing capacity by managing, such as instantiating or terminating, analyzer worker nodes 308x in the analyzer worker node pool 316 based on different criteria, such as the size and number of ingested PCAP files per time interval, a time schedule, system resource utilization, a manual operator command, and the like.

Referring to FIG. 4, the PCAP analytic environment may include a code deployment and run-time component 128 that provides a mechanism to develop analytic code to analyze PCAPs 402, and an automated process to package the analytic code as network analyzer software 404, configure a custom network analyzer for deployment as an analyzer worker node 406, and deploy a custom analyzer worker node to the analyzer worker node pool 408.

Referring to FIG. 5, the evidence collection and collaboration component 124 may provide for gathering and exchanging network traffic information, creation of analytic reports 502, inserting and sharing contextual deep links 536 inside PCAP analytic views 506, integration with third party systems 504, organizing all evidence in the storyboard format, and the like. Third party systems 504 may provide messaging 516, workflow 518, ticketing 520, and the like integration functionality with the system. Analytic reports 502 may include system generated PCAP analysis 508, file attachments 510, system screenshots 512, user notes or comments 514, and the like. Contextual deep links 536 may enable URL bookmarking of PCAP data elements, such as IP host, communications link, network artifact, and the like, in PCAP analytic views 506 for referencing a specific PCAP data element instead of the whole page as further described in FIG. 8. A contextual deep link 536 may contain a URL field, a description field, associated keywords, cross-references to related PCAP data elements, and the like. The URL field of a contextual deep link may point to specific PCAP data elements inside various PCAP analytic views 506, such as network graphs 522, timeline analysis 524, suspicious activity 526, hosts 528, communications 530, file transfers 532, data trends 534, and the like.

Referring to FIG. 6, the PCAP Malware Analyzer may perform malware extraction 602 from one or a plurality of PCAP files. The PCAP Malware Analyzer may perform malware classification and validation 604 to determine if malware is suitable for detonation. The PCAP Malware Analyzer may programmatically launch a sandbox instance and detonate 606 the malware sample. The PCAP Malware Analyzer may capture network traffic 608 from malware detonation within a sandbox environment into a PCAP file and programmatically ingest 610 via the PCAP Data Ingestion module 102 the resulting sandbox PCAP file to the system for network traffic analysis 612.

Referring to FIG. 7, a graphical user interface for a platform for PCAP exchange and analysis including a menu 702 of PCAP analytic views 506, described in FIG. 5.

Referring to FIG. 8, a PCAP analytic view in a platform for PCAP exchange and analysis may include contextual deep links 536, also described in FIG. 5, that may enable URL bookmarking of specific PCAP data elements in PCAP analytic views for referencing 806 a specific PCAP data element 804 instead of the whole page. A contextual deep link may contain a URL field, a description field, associated keywords, cross-references to related PCAP data elements, and the like.

Referring to FIG. 9, a Private PCAP space 106 GUI for a platform for PCAP exchange and analysis depicting non-limiting examples of PCAP file properties, such as a number of network connections 902, a number of network hosts 904, and network analytic tags 906.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a product may include at least one computing device in operable connection with a network; a memory that stores computer-executable components; a processor that executes the computer-executable components stored in the memory. The computer-executable components may include a PCAP data ingestion module; a private PCAP space; a PCAP analytic environment; and a PCAP network analyzer module.

According to variation 2, a computer readable medium may include non-transitory memory operable for machine instructions that are to be executed by a computer, the machine instructions when executed by the computer implement the following functions that may further include programmatically performing repeatable network traffic analysis that may further include identifying and analyzing at least one PCAP file.

Variation 3 may include a computer readable medium as in variation 2, that may further include dynamically scaling network analyzer processing loads via managing a number of at least one analyzer worker node, wherein, the at least one analyzer worker node includes at least one network analyzer.

Variation 4 may include a computer readable medium as in any of variations 2 or 3, wherein the at least one network analyzer includes a plurality of network analyzers that may further include at least two different types of network analyzers.

Variation 5 may include a computer readable medium as in any of variations 2 through 4, wherein the plurality of network analyzers are deployed on a plurality of analyzer worker nodes.

Variation 6 may include a computer readable medium as in any of variations 2 through 5, wherein programmatically performing repeatable network traffic analysis that may further include identifying and analyzing at least one PCAP file matching at least one predetermined criterion includes running at least one network analyzer instance to identify at least one PCAP file with at least one of pre-identified network traffic behavior or pre-identified PCAP file properties; and marking at least one PCAP file matching pre-identified network traffic behavior or pre-identified PCAP file properties for automated ingestion into a system; and ingesting a marked at least one PCAP file into the system.

Variation 7 may include a computer readable medium as in any of variations 2 through 6, that may further include programmatically crawling an external data source; and identifying PCAP files with at least one of network traffic behavior or pre-identified PCAP file properties matching at least one predetermined criterion.

Variation 8 may include a computer readable medium as in any of variations 2 through 7, that may further include assembling a plurality of PCAP files into a single analytic dataset.

Variation 9 may include a computer readable medium as in any of variations 2 through 8, wherein the single analytic dataset includes a new PCAP file combining individual PCAP files.

Variation 10 may include a computer readable medium as in any of variations 2 through 9, wherein the single analytic dataset includes a group of individual PCAP files marked as members of a dataset.

Variation 11 may include a computer readable medium as in any of variations 2 through 10, that may further include generating at least one report that may further include identification and analysis of at least one PCAP file.

Variation 12 may include a computer readable medium as in any of variations 2 through 11, wherein the at least one report includes user notes and system-generated analytic data.

Variation 13 may include a computer readable medium as in any of variations 2 through 12, wherein the at least one report includes at least one of a contextual deep link.

Variation 14 may include a computer readable medium as in any of variations 2 through 13, that may further include generating at least one contextual deep link that may further include a URL field to a page element of a PCAP analytic view.

Variation 15 may include a computer readable medium as in any of variations 2 through 14, wherein the at least one contextual deep link includes a URL field and at least one of a description field, associated keyword, or cross-reference to related PCAP data element.

Variation 16 may include a computer readable medium as in any of variations 2 through 15, wherein the at least one contextual deep link includes a URL field within at least one of a report, a note, a comment, an annotation, a message, a document, a file, a system-generated output, or an input to a third party system.

Variation 17 may include a computer readable medium as in any of variations 2 through 16, that may further include programmatically ingesting a sandbox PCAP file to a system for network traffic analysis.

Variation 18 may include a computer readable medium as in any of variations 2 through 17, that may further include providing a code deployment and run-time component configured to provide an automated process to package at least one analytic code to analyze PCAP files and configure at least one network analyzer for deployment.

Variation 19 may include a computer readable medium as in any of variations 2 through 18, that may further include: configuring at least one network analyzer for deployment within at least one analyzer worker node.

Variation 20 may include a product that may include at least one computing device in operable connection with a network; a memory that stores computer-executable components; a processor that executes the computer-executable components stored in the memory. The computer-executable components may include a PCAP data ingestion module configured to programmatically crawl an external data source; identify PCAP files with network traffic content matching certain criteria that may further include at least one of pre-identified network traffic behavior or pre-identified PCAP file properties; and upload the identified PCAP files to a system for network traffic analysis; and a PCAP network analyzer module configured to run executable code to programmatically perform repeatable network traffic analysis within the identified PCAP files.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

What is claimed is:

1. A product, comprising:
at least one computing device in operable connection with a network;
a memory that stores computer-executable components;
a processor that executes the computer-executable components stored in the memory, wherein the computer-executable components comprise:
a PCAP data ingestion module;
a private PCAP space;
a PCAP analytic environment; and
a PCAP network analyzer module.

2. A computer readable medium comprising:
non-transitory memory operable for machine instructions that are to be executed by a computer, the machine instructions when executed by the computer implement the following functions comprising:
programmatically performing repeatable network traffic analysis comprising identifying and analyzing at least one PCAP file.

3. A computer readable medium as in claim 2, further comprising:
dynamically scaling network analyzer processing loads via managing a number of at least one analyzer worker node, wherein, the at least one analyzer worker node comprises at least one network analyzer.

4. A computer readable medium as in claim 3, wherein the at least one network analyzer comprises a plurality of network analyzers comprising at least two different types of network analyzers.

5. A computer readable medium as in claim 4, wherein the plurality of network analyzers are deployed on a plurality of analyzer worker nodes.

6. A computer readable medium as in claim 2, wherein programmatically performing repeatable network traffic analysis comprising identifying and analyzing at least one PCAP file matching at least one predetermined criterion comprises:
running at least one network analyzer instance to identify at least one PCAP file with at least one of pre-identified network traffic behavior or pre-identified PCAP file properties;
marking at least one PCAP file matching pre-identified network traffic behavior or pre-identified PCAP file properties for automated ingestion into a system; and
ingesting a marked at least one PCAP file into the system.

7. A computer readable medium as in claim 2, further comprising:
programmatically crawling an external data source; and
identifying PCAP files with at least one of network traffic behavior or pre-identified PCAP file properties matching at least one predetermined criterion.

8. A computer readable medium as in claim 2, further comprising:
assembling a plurality of PCAP files into a single analytic dataset.

9. A computer readable medium as in claim 8, wherein the single analytic dataset comprises a new PCAP file combining individual PCAP files.

10. A computer readable medium as in claim 8, wherein the single analytic dataset comprises a group of individual PCAP files marked as members of a dataset.

11. A computer readable medium as in claim 2, further comprising:
generating at least one report comprising identification and analysis of at least one PCAP file.

12. A computer readable medium as in claim 11, wherein the at least one report comprises user notes and system-generated analytic data.

13. A computer readable medium as in claim 11, wherein the at least one report comprises at least one of a contextual deep link.

14. A computer readable medium as in claim 2, further comprising:
generating at least one contextual deep link comprising a URL field to a page element of a PCAP analytic view.

15. A computer readable medium as in claim 14, wherein the at least one contextual deep link comprises a URL field and at least one of a description field, associated keyword, or cross-reference to related PCAP data element.

16. A computer readable medium as in claim 14, wherein the at least one contextual deep link comprises a URL field within at least one of a report, a note, a comment, an annotation, a message, a document, a file, a system-generated output, or an input to a third party system.

17. A computer readable medium as in claim 2, further comprising:
programmatically ingesting a sandbox PCAP file to a system for network traffic analysis.

18. A computer readable medium as in claim 2, further comprising:
providing a code deployment and run-time component configured to provide an automated process to package at least one analytic code to analyze PCAP files and configure at least one network analyzer for deployment.

19. A computer readable medium as in claim 18, further comprising:
configuring at least one network analyzer for deployment within at least one analyzer worker node.

20. A product, comprising:
at least one computing device in operable connection with a network;
a memory that stores computer-executable components;
a processor that executes the computer-executable components stored in the memory, wherein the computer-executable components comprise:
a PCAP data ingestion module configured to:
programmatically crawl an external data source;
identify PCAP files with network traffic content matching certain criteria comprising at least one of pre-identified network traffic behavior or pre-identified PCAP file properties; and
uploading the identified PCAP files to a system for network traffic analysis; and
a PCAP network analyzer module configured to run executable code to programmatically perform repeatable network traffic analysis within the identified PCAP files.
